(19) United States
(12) Patent Application Publication
(10) Pub. No.: US 2023/0102370 A1
(43) Pub. Date: Mar. 30, 2023

(54) METHODS FOR PERFORMING MEASUREMENTS UNDER UE POWER SAVING MODES

(71) Applicant: Telefonaktiebolaget LM Ericsson (publ), Stockholm (SE)

(72) Inventors: Santhan Thangarasa, Vällingby (SE); Muhammad Ali Kazmi, Sundbyberg (SE)

(21) Appl. No.: 17/798,593

(22) PCT Filed: Feb. 11, 2021
(86) PCT No.: PCT/IB2021/051139

§ 371 Date: Aug. 10, 2022

Related U.S. Application Data
(60) Provisional application No. 62/972,996, filed on Feb. 11, 2020.

(51) Int. Cl. H04W 52/02

(52) U.S. Cl. CPC H04W 52/0245; H04W 52/0216; H04W 52/0251

(57) ABSTRACT

Systems and methods are disclosed herein that relate to adapting a measurement procedure performed by a wireless device. In one embodiment, a method performed by a wireless device for adapting a measurement procedure comprises determining that the wireless device is operating in an Operational Scenario (OS) out of a plurality of OSs and determining at least one measurement scaling factor based on the determined OS. The method further comprises adapting at least one measurement procedure based on the at least one measurement scaling factor. In this manner, the measurement procedure is adapted to the operational scenario of the wireless device.

### RELATED APPLICATIONS

This application claims the benefit of provisional patent application Ser. No. 62/972,996, filed Feb. 11, 2020, the disclosure of which is hereby incorporated herein by reference in its entirety.

### TECHNICAL FIELD

The present disclosure relates to a cellular communications system and, more specifically, to performing measurements at a wireless device in a cellular communications system.

### BACKGROUND

In a Third Generation Partnership Project (3GPP) Long Term Evolution (LTE) network, radio measurements performed by the User Equipment (UE) are typically performed on the serving cell(s) as well as on neighbor cells over some known reference symbols or pilot sequences. The measurements are done on cells on an intra-frequency carrier, inter-frequency carrier(s) as well as on inter-Radio Access Technology (RAT) carriers(s), depending upon the UE capability to support that RAT. To enable inter-frequency and inter-RAT measurements for the UE requiring gaps, the network has to configure the measurement gaps.

Measurements are performed for various purposes. Some example measurement purposes are: mobility, positioning, self-organizing network (SON), minimization of drive tests (MDT), operation and maintenance (O&M), network planning and optimization, etc. Examples of measurements in LTE are cell identification which is also known as Physical Cell Identity (PCI) acquisition, Reference Symbol Received Power (RSRP), Reference Symbol Received Quality (RSRQ), Narrowband RSRP (NRSRP), Narrowband RSRQ (NRSRQ), Sidelink RSRP (S-RSRP), Reference Signal—Signal to Interference plus Noise Ratio (RS-SINR), Channel State Information (CSI) RSRP (CSI-RSRP), acquisition of system information (SI), cell global identity (CGI) acquisition, Reference Signal Time Difference (RSTD), UE Receive (RX)—Transmit (TX) time difference measurement, Radio Link Monitoring (RLM), which consists of Out of Synchronization (out-of-sync) detection and In Synchronization (in-sync) detection, etc. CSI measurements performed by the UE are used by the network for scheduling, link adaptation, etc. Examples of CSI measurements or CSI reports are Channel Quality Indictor (CQI), Precoding Matrix Indicator (PMI), Rank Indictor (RI), etc. CSI measurements may be performed on reference signals such as Cell-specific Reference Signal (CRS), CSI Reference Signal (CSI-RS), or Demodulation Reference Signal (DMRS).

The measurements may be unidirectional (e.g., downlink (DL) or uplink (UL)) or bidirectional (e.g., having UL and DL components such as Rx-Tx, Round Trip Time (RTT), etc.).

In LTE, DL subframe # 0 and subframe # 5 carry synchronization signals i.e., both Primary Synchronization Signal (PSS) and Secondary Synchronization Signal (SSS). In order to identify an unknown cell (e.g., new neighbor cell), the UE has to acquire the timing of that cell and eventually the PCI of that cell. This is referred to as cell search or cell identification or even cell detection. Subsequently, the UE also measures RSRP and/or RSRQ of the newly identified cell to use itself and/or to report to the network. In total there, are 504 PCIs. The cell search is also a type of measurement.

Measurements are done in all Radio Resource Control (RRC) states, i.e., in RRC idle and RRC connected states.

Relaxed monitoring criteria for a neighbor cell are specified in 3GPP Technical Specification (TS) 36.304 v15.2.0. As described in TS 36.304, when the UE is required to perform intra-frequency or inter-frequency measurement, the UE may choose not to perform intra-frequency or inter-frequency measurements when:
a relaxed monitoring criterion is fulfilled for a period of T_{SearchDeltaP}, and
less than 24 hours have passed since measurements for cell reselection were last performed, and
the UE has performed intra-frequency or inter-frequency measurements for at least T_{SearchDeltaP} after selecting or reselecting a new cell.
   The relaxed monitoring criterion is fulfilled when:
(Srxlev_{Ref}−Srxlev)<S_{SearchDeltaP}
   where:
Srxlev=current Srxlev value of the serving cell (dB).
Srxlev_{Ref}=reference Srxlev value of the serving cell (dB), set as follows:
   After selecting or reselecting a new cell, or
   If (Srxlev−Srxlev_{Ref})>0, or
   If the relaxed monitoring criterion has not been met for T_{searchDeltaP}:
   the UE shall set the value of Srxlev_{Ref} to the current Srxlev value of the serving cell;
   T_{SearchDeltaP}=5 minutes, or the eDRX cycle length if eDRX is configured and the eDRX cycle length is longer than 5 minutes.

### SUMMARY

Systems and methods are disclosed herein that relate to adapting a measurement procedure performed by a wireless device. In one embodiment, a method performed by a wireless device for adapting a measurement procedure comprises determining that the wireless device is operating in an Operational Scenario (OS) out of a plurality of OSs and determining at least one measurement scaling factor based on the determined OS. The method further comprises adapting at least one measurement procedure based on the at least one measurement scaling factor. In this manner, the measurement procedure is adapted to the operational scenario of the wireless device.

In one embodiment, one of the plurality of OSs is related to the wireless device operating in low mobility. In another embodiment, one of the plurality of OSs is related to the wireless device being stationary or moving with a speed below certain threshold. In one embodiment, one of the plurality of OSs is related to the wireless device being at least not physically located at a cell edge of a serving cell of the wireless device and/or the wireless device operating in a center of the serving cell or close to a serving base station that provides the serving cell.

In one embodiment, each of the plurality of OSs is associated with a respective one or more criteria or conditions. In one embodiment, determining that the wireless device is operating in the determined OS comprises determining that the respective one or more criteria or conditions of the determined OS are met.

In one embodiment, each of the plurality of OSs is associated with at least one measurement scaling factor.

In one embodiment, determining the at least one measurement scaling factor further comprises determining the at least one measurement scaling factor based on the determined OS and a priority level of a carrier configured for measurements. In one embodiment, the priority level of the carrier is relative to a priority of a carrier of a serving cell of the wireless device.

In one embodiment, each of the plurality of OSs is associated with a plurality of measurement scaling factors. In one embodiment, each of the plurality of measurement scaling factors is of the same type for deriving the same type of measurement requirement. In one embodiment, determining the at least one measurement scaling factor comprises determining the at least one measurement scaling factor based on a rule and the plurality of measurement scaling factors of the determined OS. In one embodiment, the rule is based on a number of carriers configured for the measurements. In one embodiment, the rule is based on is based on the type of Radio Access Technologies (RATs) of the carriers configured for the measurements. In one embodiment, the plurality of measurement scaling factors comprise different types of measurement scaling factors for deriving different types of measurement requirements. In one embodiment, the different types of measurement requirements comprise measurement delay requirements. In one embodiment, the different types of measurement requirements comprise requirements related to measurement accuracy levels.

In one embodiment, determining that the wireless device is operating in an OS comprises determining that the wireless device is operating in an OS as a result of a trigger or rule, wherein the trigger or rule is either pre-defined or configured by a network node. In one embodiment, the trigger or rule comprises a trigger or rule that the wireless device is to determine its OS when operating in any low Radio Resource Control (RRC) activity state. In one embodiment, the trigger or rule comprises a trigger or rule that the wireless device is to determine its OS when operating in a particular type of low RRC activity state. In one embodiment, the trigger or rule comprises a trigger or rule that the wireless device is to determine its OS when the wireless device is explicitly configured by a network node to determine its OS. In one embodiment, the trigger or rule comprises a trigger or rule that the wireless device is to determine its OS if the wireless device battery power falls below certain threshold.

In one embodiment, adapting the at least one measurement procedure based on the at least one measurement scaling factor comprises applying the at least one measurement scaling factor to one or more reference requirements for the at least one measurement procedure.

Corresponding embodiments of a wireless device are also disclosed. In one embodiment, a wireless device for adapting a measurement procedure is configured to determine that the wireless device is operating in an OS out of a plurality of OSs, determine at least one measurement scaling factor based on the determined OS, and adapt at least one measurement procedure based on the at least one measurement scaling factor.

In one embodiment, a wireless device for adapting a measurement procedure comprises one or more transmitters, one or more receivers, and processing circuitry associated with the one or more transmitters and the one or more receivers. The processing circuitry is configured to cause the wireless device to determine that the wireless device is operating in an OS out of a plurality of OSs, determine at least one measurement scaling factor based on the determined OS, and adapt at least one measurement procedure based on the at least one measurement scaling factor.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates a method performed by a wireless device for adapting a measurement procedure, according to some embodiments of the present disclosure;

FIGS. 3 through 5 are schematic block diagrams of example embodiments of a radio access node or network node;

FIGS. 6 and 7 are schematic block diagrams of example embodiments of a wireless device or User Equipment (UE);

FIG. 8 illustrates an example embodiment of a communication system in which embodiments of the present disclosure may be implemented;

FIG. 9 illustrates example embodiments of the host computer, base station, and UE of FIG. 8;

FIGS. 10 through 13 are flow charts that illustrate example embodiments of methods implemented in a communication system such as that of FIG. 8; and

FIGS. 14 and 15 are flow charts that illustrate example embodiments of the operation of a network node in accordance with embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In some embodiments a more general term “network node” is used and it can correspond to any type of radio network node or any network node, which communicates with a UE and/or with another network node. Examples of network nodes are radio network node, gNodeB (gNB), ng-eNB, base station (BS), NR base station, TRP (transmission reception point), multi-standard radio (MSR) radio node such as MSR BS, network controller, radio network controller (RNC), base station controller (BSC), relay, access point (AP), transmission points, transmission nodes, RRU, RRH, nodes in distributed antenna system (DAS), core network node (e.g., MSC, MME, etc.), O&M, OSS, SON, positioning node or location server (e.g., E-SMLC), MDT, test equipment (physical node or software), etc.

In some embodiments the non-limiting term user equipment (UE) or wireless device is used and it refers to any type of wireless device communicating with a network node and/or with another UE in a cellular or mobile communication system. Examples of UE are wireless device supporting NR, target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), drone, USB dongles, ProSe UE, V2V UE, V2X UE, etc.

The term “radio node” may refer to radio network node or UE capable of transmitting radio signals or receiving radio signals or both.

The term radio access technology, or RAT, may refer to any RAT e.g., UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The UE performs measurements on reference signal (RS). Examples of RS are Synchronization Signal Block (SSB), Channel State Information Reference Signal (CSI-RS), Cell-specific Reference Signal (CRS), Demodulation Reference Signal (DMRS), Primary Synchronization Signal (PSS), Secondary Synchronization Signal (SSS), etc. Examples of measurements are cell identification (e.g., Physical Cell Identity (PCI) acquisition, cell detection), Reference Symbol Received Power (RSRP), Reference Symbol Received Quality (RSRQ), Synchronization Signal—RSRP (SS-RSRP), Synchronization Signal—RSRQ (SS-RSRQ), Signal to Interference plus Noise Ratio (SINR), Reference Signal—SINR (RS-SINR), Synchronization Signal—SINR (SS-SINR), Channel State Information—RSRP (CSI-RSRP), Channel State Information—RSRQ (CSI-RSRQ), acquisition of system information (SI), cell global identity (CGI) acquisition, Reference Signal Time Difference (RSTD), UE Receive (Rx)—Transmit (Tx) time difference measurement, Radio Link Monitoring (RLM), which consists of Out of Synchronization (out-of-sync) detection and In Synchronization (in-sync) detection, etc.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). As part of the 3GPP Release 16 NR UE power saving Work Item (WI) [RP-191607], methods to improve UE power consumption are being introduced in NR. One of the techniques to achieve improved power consumption is by relaxing the UE measurement requirements, which comprises at least serving cell and/or neighbor cell measurements.

According to current NR specifications, the UE in IDLE/INACTIVE state is required to perform Synchronization Signal—Reference Signal Received Power (SS-RSRP) and Synchronization Signal—Reference Signal Received Quality (SS-RSRQ) measurement on the serving cell and evaluate the cell selection criterion at least once every M1*N1 DRX cycles, where:
M1=2 if Synchronization Signal (SS)/Physical Broadcast Channel (PBCH) Measurement Time Configuration (SMTC) periodicity (T_{SMTC})>20 milliseconds (ms) and the Discontinuous Reception (DRX) cycle≤0.64 second, and
otherwise M1=1.

In one example of a relaxed measurement requirement, the UE can be allowed to measure on the cells that belong to different carriers less frequently compared to cells on the serving carrier. In a second example, the UE can be allowed to not measure at all on cells that belong to certain carriers under certain conditions, e.g., provided that the serving cell measurement quality is at least X decibels (dB) better than a threshold, serving cell measurement changes are within a margin, etc.

The relaxation of measurements can be achieved in different forms and/or may further depend on the scenarios the UE is operating in. The relation between the relaxation methods and operating scenarios is currently undefined.

Certain aspects of the present disclosure and their embodiments may provide solutions to the aforementioned or other challenges. According to a first embodiment related to a wireless device which for the following examples is a UE, the UE determines that it is operating in one out of at least two different operational scenarios (OSs) (OS #1 (low mobility) and OS #2 (not-at-cell edge)), determines one or more measurement scaling factors associated with the determined OS in which the UE is operating, and adapts a measurement procedure based on the determined measurement scaling factor(s). The operational scenarios comprises:
OS#1 (Low Mobility): In OS#1, the UE may be stationary or moving with a speed below certain threshold.
OS#2 (Not-at-Cell-Edge): In OS#2, the UE is at least not physically located at the cell edge and it may be operating in the center of the cell or close to the serving base station etc.

Each of the two OSs is associated with its respective one or more criteria or conditions. The UE determines the OS in which it is operating provided that the corresponding criteria for that OS are met. Each operational scenario is associated with at least one measurement scaling factor. For example:
At least measurement scaling factor K1 is used for adapting the measurement procedure when the UE is operating in OS #1,
At least measurement scaling factor K2 is used for adapting the measurement procedure when the UE is operating in OS #2.

In a second aspect of the embodiment, the measurement scaling factor associated with each OS depends on a priority level of the carrier configured for measurements. For example, the scaling factors K1 and K2 for OS#1 and OS#2 are associated with measurements on carriers configured with low or equal priority levels, while scaling factors K1′ and K2′ for OS#1 and OS#2 are associated with measurements on carriers configured with higher priority level.

In a third aspect of the embodiment, each OS is associated with multiple measurement scaling factors (e.g., K11, K12, . . . , K1n for OS#1 etc.) of the same type for deriving the same type of measurement requirement. Then, in one example, the measurement scaling factor for adapting the measurement procedures is derived based on a rule e.g., the derived measurement scaling factor is based on a number of carriers configured for the measurements, the derived measurement scaling factor is based on the type of Radio Access Technologies (RATs) of the carriers configured for the measurements, etc.

In a fourth aspect of the embodiment, one OS is associated with different types of measurement scaling factors for deriving different types of measurement requirements. For example, factor K (e.g., K1) is used for deriving measurement delay requirements when associated to OS (e.g., when operating in OS#1), factor L (e.g., L1) is used for deriving requirements related to measurement accuracy levels when associated to OS (e.g., when operating in OS#1), etc. In this case, the UE uses the different types of measurement scaling for adapting the measurement procedure to ensure that the corresponding requirements are met. Each type of the measurement scaling factor may further be derived from a set of the scaling factors based on a rule as in the previous example (second aspect).

The term measurement scaling factor used herein may also be referred to as a measurement relaxation factor, a relaxation factor, etc.

There are, proposed herein, various embodiments which address one or more of the issues disclosed herein. In some embodiments, a method performed by a wireless device for adapting a measurement procedure includes determining that the wireless device is operating in an OS out of a plurality of OSs; determining at least one measurement scaling factor based on the determined OS; and adapting at least one measurement procedure based on the at least one measurement scaling factor.

In some embodiments, one of the plurality of OSs is related to the wireless device being stationary or moving with a speed below certain threshold. In some embodiments, one of the plurality of OSs is related to the wireless device being at least not physically located at a cell edge and/or the wireless device is operating in the center of the cell or close to the serving base station. In some embodiments, each of the plurality of OSs is associated with its respective one or more criteria or conditions. In some embodiments, determining that the wireless device is operating in the determined OS comprises determining the respective one or more criteria or conditions of the determined OS are met.

In some embodiments, each of the plurality of OSs is associated with at least one measurement scaling factor. In some embodiments, determining the at least one measurement scaling factor further comprises determining the at least one measurement scaling factor based on the determined OS and a priority level of a carrier configured for measurements. In some embodiments, the priority level of the carrier is one of: a low priority level, an equal priority level, and a higher priority level.

In some embodiments, each of the plurality of OSs is associated with a plurality of measurement scaling factors. In some embodiments, each of the plurality of measurement scaling factors is of the same type for deriving the same type of measurement requirement.

In some embodiments, determining the at least one measurement scaling factor comprises determining the at least one measurement scaling factor based on a rule and the plurality of measurement scaling factors of the determined OS. In some embodiments, the rule is based on a number of carriers configured for the measurements. In some embodiments, the rule is based on is based on the type of RATs of the carriers configured for the measurements.

In some embodiments, the plurality of measurement scaling factors comprise different types of measurement scaling factors for deriving different types of measurement requirements. In some embodiments, the different types of measurement requirements comprise measurement delay requirements. In some embodiments, the different types of measurement requirements comprise requirements related to measurement accuracy levels.

In some embodiments, determining that the wireless device is operating in an OS is a result of a trigger or rule, which can be pre-defined or configured by the network node. In some embodiments, the rule comprises the wireless device evaluating the status of its OS when operating in any low Radio Resource Control (RRC) activity state e.g., in idle state, in inactive state, etc. In some embodiments, the rule comprises the wireless device evaluating the status of its OS when operating in a particular type of low RRC activity state e.g., only in idle state or only in inactive state, etc. In some embodiments, the rule comprises the wireless device evaluating the status of its OS when it is explicitly configured by the network node to perform the evaluation. In some embodiments, the rule comprises the wireless device evaluating the status of its OS if the wireless device battery power falls below certain threshold (e.g., below 25% of the maximum battery power).

In some embodiments, a method performed by a base station for adapting a measurement procedure includes receiving a measurement from a wireless device where the measurement procedure was adapted based on at least one measurement scaling factor.

In some embodiments, a method performed by a base station for adapting a measurement procedure includes configuring a wireless device with a trigger or rule for when the wireless device determines that the wireless device is operating in an OS out of a plurality of OSs.

Certain embodiments may provide one or more of the following technical advantage(s). Some embodiments enable the wireless device or UE to have different levels of relaxation depending on the operating scenario. For example, UEs with limited mobility can tolerate more relaxation compared to UEs with moderate mobility, and UEs not located at cell-edge can have different level of relaxation compared to UEs at cell border etc.

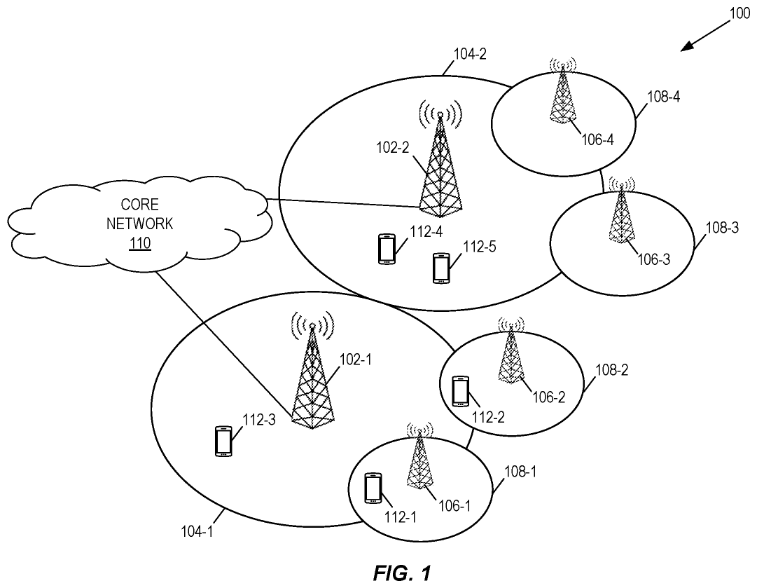

FIG. 1 illustrates one example of a cellular communications system 100 in which embodiments of the present disclosure may be implemented. In the embodiments described herein, the cellular communications system 100 is a 5G system (5GS) including a NR RAN or LTE RAN (i.e., E-UTRA RAN) or an Evolved Packet System (EPS) including an LTE RAN. In this example, the RAN includes base stations 102-1 and 102-2, which in LTE are referred to as eNBs (when connected to EPC) and in 5G NR are referred to as gNBs or next-generation eNBs (ng-eNBs) (i.e., LTE RAN nodes connected to the 5G core (5GC)), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5G core (5GC). The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such sometimes referred to herein as UEs 112, but the present disclosure is not limited thereto.

Embodiments of the present disclosure relate to the following scenario. The scenario comprises at least one UE (e.g., at least one UE 112) which is operating in a first cell (cell1) (first cell 104) served by a network node (NW1) (e.g., a first base station 102), and performing measurements on its serving cell and one or more neighbor cells, e.g., on serving carrier and/or one or more additional carriers configured for measurements. Any additional carrier may belong to the RAT of the serving carrier frequency. In this case if that carrier is non-serving carrier, then it is referred to as an inter-frequency carrier. The additional carrier may also belong to another RAT, in which case it is referred to as an inter-RAT carrier. The term carrier may also interchangeably be referred to as a carrier frequency, layer, frequency layer, carrier frequency layer, etc. For consistency, the term carrier is used herein. Configured carriers can also be associated with different priority levels compared to the priority level of the serving cell e.g., low priority, equal priority, or higher priority. The measurement rules depend on the priority level of the carrier. For example, carriers of higher priority are required to be searched by the UE periodically but with very long periodicity e.g., once every 60 seconds. The carriers of low or equal priories are required to be measured typically once every Discontinuous Reception (DRX) cycle but only when the serving cell signal level falls below certain threshold. The UE is further configured to evaluate at least two different operational scenarios (OS#1 and OS#2) in which it may operate. Each operational scenario is associated with at least one measurement scaling factor. In OS#1, the UE operates in low mobility and, in OS#2, the UE operates in the cell center or at least not at the cell edge.

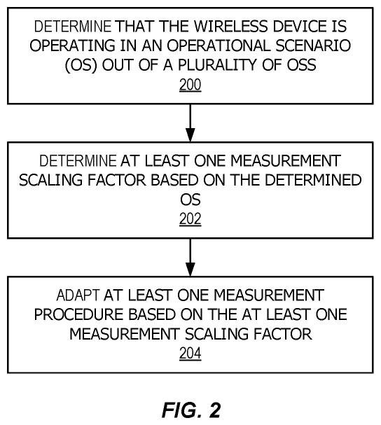

The embodiments described herein may be implemented in any combination. FIG. 2 illustrates a method performed by a wireless device (e.g., a wireless device 112 or UE) for adapting a measurement procedure, according to some embodiments of the current disclosure. The wireless device determines that the wireless device is operating in an OS out of a plurality of OSs (step 200). The wireless device determines at least one measurement scaling factor based on the determined OS (step 202). The wireless device then adapts at least one measurement procedure based on the at least one measurement scaling factor (step 204).

In some embodiments, these steps can include some or all of the following:
Step 200: The wireless device determines one of the at least two operational scenarios (OSs) in which it is operating.
   Example of operating scenarios include:
      OS#1: Low mobility scenario
      OS#2: Not in cell-edge scenario
Step 202: The wireless device determines a measurement scaling factor based on the determined operational scenario.
Step 204: The wireless device adapts a measurement procedure based on the determined scaling factor e.g., measures and evaluates cells on the configured carriers according to the measurement requirements derived based on the determined value of scaling factor.

These steps are described in detail in below subsections. In the following description, the wireless device is a UE.

In some embodiments of step 200, the UE determines one of the at least two operational scenarios in which the UE is currently operating i.e., the status of its operational scenario. The determination can be based on one or more basic or rudimentary or essential criteria as described below. Therefore, each scenario is associated with one or more criteria. If the UE meets the one or more criteria, then the UE assumes that it is operating in a scenario associated with those criteria. The UE may evaluate whether the UE is operating in one of the two operational scenarios based on a trigger or rule, which can be pre-defined or configured by the network node. Examples of a rule are:
In one example of a rule, the UE evaluates the status of its operational scenarios when operating in any low RRC activity state e.g., in idle state, in inactive state, etc.
In another example of a rule, the UE evaluates the status of its operational scenarios when operating in a particular type of low RRC activity state e.g., only in idle state or only in inactive state etc.
In yet another example of a rule, the UE evaluates the status of its operational scenarios when it is explicitly configured by the network node (e.g., base station 102) to perform the evaluation.
In yet another example of a rule, the UE evaluates the status of its operational scenarios if the UE battery power falls below a certain threshold (e.g., below 25% of the maximum battery power).

The determination of the operational scenario based on one or more criteria is elaborated below for both scenarios:

Operational Scenario # 1—low mobility: One example of operational scenario under which the UE is allowed to perform relaxed monitoring of measurements is based on the mobility state of the UE. For example, if the UE is in low mobility state, then the UE is allowed to enter into the relaxed monitoring state for one or more cells e.g., neighbor cells. The term low mobility or state of low mobility implies that the UE is stationary or moving at a speed below certain speed threshold, which can be pre-defined or configured by the network node. Examples of parameters defining UE speed comprises Doppler speed (e.g., X1 Hz), speed expressed in distance per unit time (e.g., X2 km/hour), etc. The UE therefore obtains information related to UE mobility which indicates whether it is a mobile or stationary UE and UE speed if it is mobile. This information is referred to herein as “mobility information”. The criteria for determining that the UE is in low mobility state comprises one or more of the following:
In one example, the mobility information can be explicit information (e.g., higher layer signaling, or subscription data) indicating the mobility state of the UE, e.g., whether it is stationary or mobile.
In another example, the mobility information can also be implicit information indicating the UE mobility. One such example is using the relaxed cell monitoring criterion (as defined in TS 36.306 v15.2.0 and described in section 2.1.1.3) for determining the mobility state of the UE. The relaxed cell monitoring criterion comprises numerous conditions to decide whether the UE can choose not to perform intra-frequency or inter-frequency measurements. The conditions are chosen such that the UE is allowed not to perform intra-frequency and inter-frequency measurements only when the UE has limited mobility e.g., stationary or substantially stationary. When the relaxed monitoring conditions are met, it is an indication that the UE does not move very much, or it can be stationary. Under such circumstances, the UE is required to only measure on the serving cell, and it is allowed to skip the neighbor cell measurement.
In yet another example, the UE can also obtain the information about the UE mobility state from the other nodes, e.g., network node, signaling the mobility state of the UE.
In yet another example, the UE can also estimate its own speed and compare it with certain threshold to determine whether the UE is in low mobility state or not.

Operational Scenario # 2—Not-at-cell-edge: Another example of operational scenario under which the UE is allowed to perform relax monitoring of measurements is based on the location of the UE in the serving cell. For example, the UE is considered to be in operational scenario #2 if the UE is not in the cell-edge of the serving cell or if it is in the center of the serving cell or if it is close to the serving base station. The UE determines whether it is in cell-edge area of a cell and uses this information for further determining a measurement scaling factor (as described in step 202). The determination can be based on a comparison between a signal level measured by the UE with respect to cell1 and a threshold. For example, if the measured signal level (e.g., SS-RSRP, SS-RSRQ, etc.) is below a certain threshold (H), then the UE may assume that it is in the cell edge; otherwise, the UE is assumed not to be in the cell edge (rather closer to the serving base station). The value of H can be pre-defined or configured by the network node.

Explicit indicator: The UE can also be signaled to operate using a certain relaxed measurement mode. Such signaling may come from e.g., the serving network node using dedicated RRC signaling which UE obtains from the CONNECTED state and uses it in IDLE mode. Similar indicator can also be used for selecting relaxed measurement modes in CONNECTED mode.

Reference scenario: This is the scenario used as reference for deriving the new requirements in the relaxed measurement states. The scaling factor for reference scenario (Kn) is assumed to be 1.

In some embodiments of step 202, different aspects of the embodiments are described below.

### First Aspect of the UE Embodiment:

According to the first aspect of the UE embodiment, the UE determines at least one measurement scaling factor based on the determined operational scenario in step 200. At a high level, it is assumed that each OS is associated with at least one measurement scaling factor. The term measurement relaxation factor may also be referred to as a scaling factor, a measurement scaling factor, etc.

The determined scaling factor is used for deriving one or more measurement requirements. For example:
scaling factor K1 is used when the UE is operating in OS #1, and
scaling factor K2 is used when the UE is operating in OS #2.
   This means when the UE is operating in OS #1, the new requirements are derived by scaling the reference scenario requirements with factor K1. Similarly, the requirements for a UE that operates in OS #2 are derived by scaling the reference scenario requirements with factor K2.

Within a determined operational scenario, UEs typically have similar configurations and/or behavior, which includes (but not limited to) UE mobility, DRX configurations, device type, geographical location, traffic behavior, etc. If it was determined in step 200 that some UEs are operating in OS#1, those UEs are expected have reduced mobility compared to a reference scenario. They can be sensor type of devices (IoT) which have a fixed geographical position, and/or they can have a certain traffic behavior. In this case, the scaling factor K1 can have a large value compared to the reference case Kn which makes the requirements more relaxed. Such relaxation can be both in time domain and accuracy domain, e.g., extended measurement delay, higher tolerance for the measurement bias. The relaxation can also be in frequency domain, e.g., in terms of number of non-serving carriers to monitor.

Similarly, if it was determined in step 200 that some UEs are operating in OS#2, those UEs are expected to have a different behavior in terms of e.g., mobility, device type, DRX configuration etc. than those operating in OS#1. For example, those UEs can be of high-speed, and therefore be configured with shorter DRX compared to the previous scenario with criteria#1. Therefore, it is reasonable to assume values of K2 which are different than the values of K1. Since these UEs are not of low-mobility, the scaling factor indicating the number of carriers to search/measure/monitor can be higher than the corresponding factor for UEs in OS#1.

In a first example, it is assumed that K1>K2 because UEs operating in OS#1 can be configured with (or expected to be configured with) long DRX cycles lengths or extended DRX (eDRX) compared to UEs operating in OS#2 because they have limited or reduced mobility compared to UEs in OS#2. Therefore, configurations can be such UEs in OS#1 are in DRX OFF more frequently than UEs operating in OS#2. In a specific example, UEs in OS#1 can be configured with enhanced DRX (eDRX) while UEs in OS#2 are configured with normal DRX.

In a second example, it is assumed that K1>K2 because UEs operating in OS#1 can be IoT (sensor) type of devices while UEs operating in OS#2 can be handheld devices.

In a third example, it is assumed that K2>K1 because UEs operating in OS#1 can be anywhere within a cell compared to UEs operating in OS#2 which are e.g., not at cell-edge or near a serving node where the coverage is typically not an issue. The requirements can therefore be more relaxed, e.g., the UEs measure on neighbor cells over longer time.

In yet another example, the measurement scaling factor for each OS depends on the time elapsed (Te) since last measurement was performed for cell re-selection (e.g., neighbor cell measurements, RSRP, RSRQ). For example, if Te<H (threshold), then the measurement scaling factor is set to a larger value compared to the case when Te≥H. For example, H=3 hours. The threshold can be set differently depending on the OS, e.g., a scenario (OS#1) where the UE is expected to be stationary or have low mobility, the threshold is set to a larger value compared to OS where the UE can be moving at high-speed (OS#2). For example, in OS#1 H=4 hours, and in OS#2 H=2 hours. The value of H can be pre-defined, configured by the network node, or autonomously determined by the UE depending on the identified OS.

### Second Aspect of the UE Embodiment:

According to a second aspect of the UE embodiment, the scaling factors used in OS#1 and OS#2 depend on the priority levels of the carriers configured for the measurements. This is explained with examples below.

In a first exemplary implementation where the scaling factor is based on priority level of carriers:
a first set (S1) of the scaling factors are used for adapting the measurement procedures related to measurements done on carriers of equal to or lower priority levels with respect to the priority level of the serving carrier, and
a second set (S2) of the scaling factors are used for adapting the measurement procedures related to measurements done on carriers of higher priority level with regard to the priority level of the serving carrier, where the values of the scaling factors in sets S1 and S2 are different.

In a second exemplary implementation where the scaling factor is based on priority level of carriers:
a first set (S1) of the scaling factors are used for adapting the measurement procedures related to measurements done on carriers of equal priority level with regard to the priority level of the serving carrier,
a second set (S2) of the scaling factors are used for adapting the measurement procedures related to measurements done on carriers of lower priority level with regard to the priority level of the serving carrier, and
a third set (S3) of the scaling factors are used for adapting the measurement procedures related to measurements done on carriers of higher priority level with regard to the priority level of the serving carrier, where the values of the scaling factors in sets S1, S2 and S3 are different.

The first exemplary implementation is further elaborated as follows. The UE determines scaling factors K1′ and K2′ (set S2) that are used for deriving the measurement requirements of cells that belong to carriers of higher priority. The scaling factors K1′ and K2′ are specific to measurements of higher priority carriers only. This means the legacy RRM measurements herein referred to the RRM measurements of cells that belong to carriers of equal priority or lower priority which are carried out using different scaling factors (K1 and K2 in set S1).

In some embodiments, the scaling factors are determined based on the determined OS. The relation between set S2 (K1′, K2′) and set S1 (K1, K2) depends on several factors such as type of operational scenario of the UE (OS#1, OS#2,), UEs geographical location, number of RATs supported, DRX configurations, types of devices, number of configured carriers of higher priority, number of configured carriers of lower or equal priority, etc. The purpose of measuring higher priority carriers is different from measuring on normal carriers (low priority and equal priority carriers). Typically, the higher priority carriers are used for load balancing while the other carriers (e.g., carriers of equal or lower priority) are used for maintaining the coverage and mobility of the UE. Therefore, it is reasonable to assume different scaling factors are used for higher priority carriers compared to those used for the carriers of low or equal priority levels.

In one example, the UEs operating in OS#1 may assume a larger value for K1′ compared to K1. The reason is that K1 measurements are used for mobility purpose while K1′ measurements are used for load balancing. Since low mobility devices may typically not generate a lot of traffic, load balancing becomes less interesting use case here.

In another example, the UEs operating in OS#2 may assume a smaller value for K2′ compared to K2 because these UEs are expected to be in good coverage when they are not at cell edge or near the serving base station. In such scenario, load balancing is more relevant use case and by having a smaller scaling factor for the higher priority carriers than for normal carriers, they become less relaxed.

The scaling factors within set S2 (K1′ and K2′) may also be related to each other based on one or more criteria. K1′ and K2′ are different. The relation between K1′ and K2′ is described using the examples below.

In another example, K2′<K1′ because UEs operating in OS#2 can be of high-speed which is not the case for UEs operating in OS#1. By having a smaller value for K2′ compared to K1′, the high-speed UEs are able to finish the higher priority measurements faster.

In yet another example, the values of K1′ and K2′ may depend on the number of configured carriers. Typically, the higher priority carriers are measured with a certain periodicity (e.g., once every 60 ms) under certain conditions (e.g., when Srxlev>S_{nonIntraSearchP} and Squal>S_{nonIntraSearchQ}). According to legacy systems, measurements of higher priority carriers do not depend on the number of configured carriers nor on the maximum number of carriers the UE is capable of measuring. However, with the introduction of support for relaxed measurement modes, changing this behavior may improve measurement performance of higher priority carriers and this may in turn improve the network performance e.g., the load balancing.

One example of the relation between K1′ and K2′ and the number of configured carriers is shown in Table 1. Since load balancing is more relevant use case when UEs are operating in OS#2 than in OS#1, it is reasonable to assume that X1′>X2′.

In another example, if the UE is operating in OS#1, and N is large, then it is reasonable to assume a large value for scaling factor for the higher priority carriers. This is because due to limited UE mobility in OS#1 it is still not very relevant or very useful to measure on all the configured carriers even if there is large number of configured carriers for measurements. On the other hand, if the UE is operating in OS#2 and N is large, then it is reasonable to assume a small value for the scaling factor for the higher priority carriers because UEs can be moving and still be within good coverage of the cell which makes load balancing relevant.

TABLE 1
Example showing the relation between scaling factors of higher
priority carriers and number of configured carriers (N)

| | N = 2 | N = 4 | N = 6 |
|---|---|---|---|
| K1′ | X1′ | Y1′ | Z1′ |
| K2′ | X2′ | Y2′ | Z2′ |

A general rule can be that the scaling factor decreases as N increases for OS#2. The reason is that UE needs more time to measure on the different carriers when N increases because the non-serving carrier measurements are typically measured sequentially and relaxing the requirements further in this case may degrade the performance. The relation between scaling factors for higher priority carriers based on N can be expressed as: (X1′>Y1′>Z1′), and (X2′>Y2′>Z2′). The relation between the scaling factors of higher priority carriers for UE operating under OS#1 and OS#2 is expressed as follows: (X1′>X2′), (Y1′>Y2′) and (Z1′>Z2′).

As a special case, in certain implementation, the rule can be the opposite for UEs operating in OS#1, i.e., the scaling factor increases with N for the higher priority carriers. The reason is that the UE power consumption increases as the number of carriers to measure increases. By setting or assuming a smaller value for the scaling factor, the measurement period is extended, i.e., the UE is allowed to perform the same measurement over longer time and this helps reducing the UE power consumption. Since the UEs in OS#1 have limited mobility and load balancing feature is typically not time-critical, extending the measurement period of the higher priority carriers can be acceptable. For example the set of the scaling factors K1′ and K2′ as function of N in Table 3 are related according to the following expressions (X1′<Y1′<Z1′) and (X2′ >Y2′>Z2′) respectively. This rule may be applied for example if UE battery power falls below certain threshold. In another example the UE can be configured by the network node whether the UE shall apply the general rule (above) or the special rule for deriving the scaling factors for measurements on higher priority carriers based on its operational scenario.

### Third Aspect of the UE Embodiment:

According to a third aspect of the embodiment, the scaling factors depend on the number carriers the UE supports or is capable of measuring or has been configured to measure. The maximum number of carriers (M) that a UE supports is a UE capability, but it can be configured by the serving network node to measure on N number of carriers (i.e., both serving and non-serving) where N≤M. Since the measurement opportunity of a certain carrier (f₁) decreases with increase in N, it is reasonable to assume a lower scaling factor when N is high. On the other hand, a larger scaling factor can be assumed when N is low. One example is shown in Table 2 where it is shown how the scaling factors depend on N. The scaling factor decreases as N increases, and the reason is that UE needs more time to measure on the different carriers when N increases because the non-serving carrier measurements are typically measured sequentially and relaxing the requirements further in this case may degrade the performance. Therefore, the relation between the scaling factors as with regard to number of configured carriers (N) are such that: (X1>Y1>Z1), (X2>Y2>Z2) etc. The relation between the scaling factors of carriers for UE operating under OS#1 and OS#2 is expressed as follows: (X1>X2), (Y1>Y2) and (Z1>Z2).

TABLE 2
Example showing the relation between scaling factors and number
of configured carriers

| | N = 2 | N = 4 | N = 6 |
|---|---|---|---|
| K1 | X1 | Y1 | Z1 |
| K2 | X2 | Y2 | Z2 |

Similarly, a UE that supports or measures on more RATs (i.e., inter-RAT measurements) may assume a low or smaller value for the scaling factor compared to a UE only supports a single RAT or fewer RATs. In one example, the scaling factor may further depend on the type of RATs (inter-RATs) that it is measuring on. For example, a UE operating in a NR cell measuring on an LTE cell may assume a large value for the scaling factor compared to a UE operating in a NR cell and measuring on a UMTS cell. A smaller scaling factor speeds up the total measurement delays. Similarly, a UE which is measuring on fewer inter-RAT cells (e.g., LTE cell) may assume a larger scaling factor compared to a UE that is measuring on more inter-RAT cells (e.g., LTE cell, UMTS cell, GSM cells).

As a special case, in a certain implementation, the rule can be the opposite to the examples described above, i.e., the scaling factor increases with N for the carriers of equal and/or lower priority. The reason is that the UE power consumption increases as the number of carriers to measure increases. By setting or assuming a large value for the scaling factor, the measurement period is extended, i.e., the UE is allowed to perform the same measurement over longer time and this helps reducing the UE power consumption while the UE can still identify and measure on the neighboring cells. This can be especially of importance for the UEs operating in OS#1. Also in this case the set of the scaling factors K1 and K2 as function of N in Table 2 can be related according to the following expressions (X1<Y1<Z1) and (X2>Y2>Z2) respectively. This rule may also be applied for example if UE battery power falls below certain threshold. In another example the UE can be configured by the network node whether the UE shall apply the general rule (above) or the special rule for deriving the scaling factors for measurements on carriers of equal or lower priority levels based on its operational scenario.

UEs operating in the same operating scenario have similar UE behavior and configurations, and thus the relation between K1 and K2 also depends on that behavior and configurations. In one example, the relation can be as follows in (1) because UEs in OS#1 have less mobility than UEs in OS#2:

K1>K2 (1)

Example values of K1 and K2 are 4 and 2 respectively.

### Fourth Aspect of the UE Embodiment:

According to a fourth aspect of the UE embodiment, one OS is associated with different types of measurement scaling factors for deriving different types of measurement requirements. For example:
factor K (e.g., K1) is used for deriving measurement delay requirements when associated to the OS (e.g., OS#1 is met),
factor L (e.g., L1) is used for deriving requirements related to measurement accuracy levels when associated to the OS (e.g., criteria#1 is met) etc., and
factor P (e.g., P1) is used for deriving the frequency domain requirements when associated to the OS (e.g., OS#1).

The operations used for deriving the new requirements include addition, subtraction, multiplication, division. For example, the delay requirements (time-domain requirements) that apply in an OS are derived by multiplying the corresponding reference requirements with the determined scaling factor. But the measurement accuracy (dB domain requirements) is determined by adding or subtracting the reference requirements with the determined scaling factor. But the frequency domain requirements (e.g., number of carriers to measure) can be derived using any of the operations multiplication, division, addition, or subtraction.

An example is shown in Table 3, where factor K deriving the measurement delay requirements, factor L is used for deriving the requirements related to measurement accuracy levels etc.

TABLE 3
Example showing having different types of scaling factors for
deriving different types of requirements

| Type of | | | |
|---|---|---|---|
| requirements | Scaling factor | Operation | Values |
| Delay requirements | K | Multiplication | 1, 2, 3, 4, . . . |
| Accuracy | L | Addition | +0.5 dB, −0.5 dB, |
| requirements | | | +1 dB, −2 dB. |

In this case the UE uses the different types of measurement scaling for adapting the measurement procedure to ensure that the corresponding requirements are met. Each type of the measurement scaling factor may further be derived from a set of the scaling factors based on a rule as in the previous example (second aspect).

In some embodiments of step 204, the UE adapts a measurement procedure based on the determined measurement scaling factor in step 202. The adaptation of the measurement procedure could include one or more of the following:
deriving a measurement requirement for a measurement based on the determined scaling factor(s). Examples of deriving the measurement requirements are described further below,
adapting measurement rate at which the UE obtains measurement samples based on the scaling factor,
performing one or more measurements while meeting the derived measurement requirements,
using the results of the performed measurements for one or more operational tasks. The operational tasks comprise, using the measurement results for evaluating different criteria (e.g., for different types of cell change such as cell re-selection, handover, RRC re-establishment), reporting those measurements or result of those measurements to different nodes (e.g., NW1, another UE), etc.

As specific example of rule for deriving new measurement requirements for measurements on higher priority carriers can be specified in the specification as follows:
If the UE is operating in operational scenario#1 then the UE shall search every layer of higher priority at least every T_{higher_priority_search}=60 *K1′* N_{layers}) seconds, where N_{layers} is the total number of higher priority NR and E-UTRA carrier frequencies broadcasted in system information;
Otherwise, if the UE is operating in operational scenario#2 then the UE shall search every layer of higher priority at least every T_{higher_priority_search}=60 * K2′*N_{layers}) seconds, where N_{layers} is the total number of higher priority NR and E-UTRA carrier frequencies broadcasted in system information; where K1′and K2′ are different. In one specific example K′2<K1′. In another specific example K′2=1 and K1′>1. In yet another specific example K′2=1 and K1′=2.

Another specific example of deriving the new delay requirements (time-domain requirements) for UE in low activity states by apply the scaling factor K based on the OS of the UE is shown in Table 4 for intra-frequency measurements and in Table 5 for inter-frequency measurements. In this example for intra-frequency measurements the UE shall meet requirements in Table 4:
with K=K1 if the UE is operating in OS#1; and
with K=K2 if the UE is operating in OS#2; where K1 and K2 are different for at least one of the following sets of requirements: cell detection delay (T_{detect,NR_Intra}), measurement time (T_{measure,NR_Intra}) and evaluation period (T_{evaluate,NR_Intra}).

Also, in the above example for inter-frequency measurements, the UE shall meet requirements in Table 5:
with K=K1 if the UE is operating in OS#1; and
with K=K2 if the UE is operating in OS#2; where K1 and K2 are different for at least one of the following sets of requirements: cell detection delay (T_{detect,NR_Inter}), measurement time (T_{measure,NR_Inter}) and evaluation period (T_{evaluate,NR_Inter}). The values of K1 and K2 can be the same for intra-frequency and inter-frequency measurements, or they can be different for intra-frequency and inter-frequency measurements.

TABLE 4
T_{detect, NR}_{_{—}}_{Intra}, T_{measure, NR}_{_{—}}_{Intra} and
T_{evaluate, NR}_{_{—}}_{Intra} for intra-frequency measurements

| DRX | | | | | |
|---|---|---|---|---|---|
| cycle | Scaling Factor | | T_{detect}, _{NR}_{_{—}}_{Intra} [s] | T_{measure, NR}_{_{—}}_{Intra} [s] | T_{evaluate, NR}_{_{—}}_{Intra} [s] |
| length | (N1) | | (number of DRX | (number of DRX | (number of DRX |
| [s] | FR1 | FR2^{Note1} | cycles) | cycles) | cycles) |
| 0.32 | 1 | 8 | 11.52 × N1 × | 1.28 × N1 × | 5.12 × N1 × M2 |
| | | | M2 × K (36 × | M2 × K (4 × | (16 × N1 × M2) |
| | | | N1 × M2 × K) | N1 × M2 × K) | |
| 0.64 | | 5 | 17.92 × N1 × K | 1.28 × N1 × | 5.12 × N1 × K |
| | | | (28 × N1 × K) | K (2 × N1 × K) | (8 × N1 × K) |
| 1.28 | | 4 | 32 × N1 × K | 1.28 × N1 × | 6.4 × N1 × K |
| | | | (25 × N1 × K) | K (1 × N1 × K) | (5 × N1 × K) |
| 2.56 | | 3 | 58.88 × N1 × K | 2.56 × N1 × | 7.68 × N1 × K |
| | | | (23 × N1 × K) | K (1 × N1 × K) | (3 × N1 × K) |

^{Note1}:
Applies for UE supporting power class 2&3&4. For UE supporting power class 1, N1 = 8 for all DRX cycle length.
Note 2:
M2 = 1.5 if SMTC periodicity of measured intra-frequency cell > 20 ms; otherwise M2 = 1.

TABLE 5
T_{detect, NR}_{_{—}}_{Inter}, T_{measure, NR}_{_{—}}_{Inter} and
T_{evaluate, NR}_{_{—}}_{Inter} for inter-frequency measurements

| DRX | | | | | |
|---|---|---|---|---|---|
| cycle | Scaling Factor | | T_{detect, NR}_{_{—}}_{Inter} [s] | T_{measure, NR}_{_{—}}_{Inter} [s] | T_{evaluate, NR}_{_{—}}_{Inter} [s] |
| length | (N1) | | (number of DRX | (number of DRX | (number of DRX |
| [s] | FR1 | FR2^{Note1} | cycles) | cycles) | cycles) |
| 0.32 | 1 | 8 | 11.52 × N1 × | 1.28 × N1 × | 5.12 × N1 × |
| | | | 1.5 × K (36 × | 1.5 × K (4 × | 1.5 × K (16 × |
| | | | N1 × 1.5 × K) | N1 × 1.5 × K) | N1 × 1.5 × K) |
| 0.64 | | 5 | 17.92 × N1 × K | 1.28 × N1 × K | 5.12 × N1 × K |
| | | | (28 × N1 × K) | (2 × N1 × K) | (8 × N1 × K) |
| 1.28 | | 4 | 32 × N1 × K | 1.28 × N1 × K | 6.4 × N1 × K |
| | | | (25 × N1 × K) | (1 × N1 × K) | (5 × N1 × K) |
| 2.56 | | 3 | 58.88 × N1 × K | 2.56 × N1 × K | 7.68 × N1 × K |
| | | | (23 × N1 × K) | (1 × N1 × K) | (3 × N1 × K) |

^{Note 1}:
Applies for UE supporting power class 2&3&4. For UE supporting power class 1, N1 = 8 for all DRX cycle length.

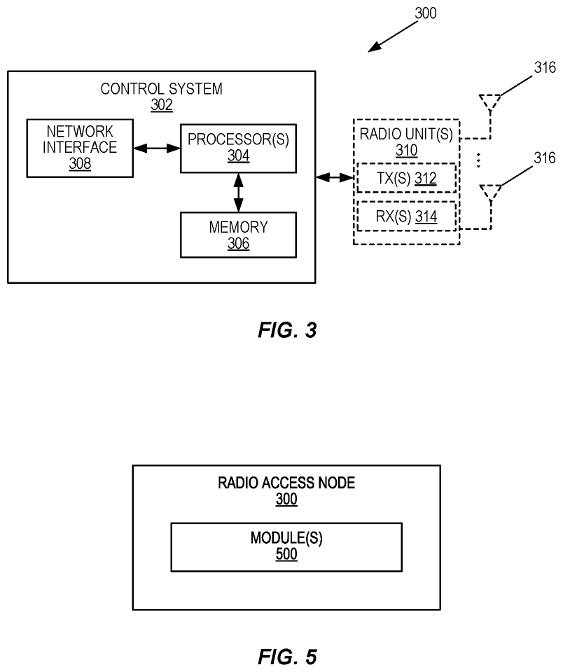

FIG. 3 is a schematic block diagram of a radio access node 300 according to some embodiments of the present disclosure. As used herein, a “radio access node” is a type of network node that is in the radio access network (RAN) of a cellular communications system. Optional features are represented by dashed boxes. The radio access node 300 may be, for example, a base station 102 or 106 or a network node that implements all or part of the functionality of the base station 102 or gNB described herein. As illustrated, the radio access node 300 includes a control system 302 that includes one or more processors 304 (e.g., Central Processing Units (CPUs), Application Specific Integrated Circuits (ASICs), Field Programmable Gate Arrays (FPGAs), and/or the like), memory 306, and a network interface 308. The one or more processors 304 are also referred to herein as processing circuitry. In addition, the radio access node 300 may include one or more radio units 310 that each includes one or more transmitters 312 and one or more receivers 314 coupled to one or more antennas 316. The radio units 310 may be referred to or be part of radio interface circuitry. In some embodiments, the radio unit(s) 310 is external to the control system 302 and connected to the control system 302 via, e.g., a wired connection (e.g., an optical cable). However, in some other embodiments, the radio unit(s) 310 and potentially the antenna(s) 316 are integrated together with the control system 302. The one or more processors 304 operate to provide one or more functions of a radio access node 300 as described herein. In some embodiments, the function(s) are implemented in software that is stored, e.g., in the memory 306 and executed by the one or more processors 304.

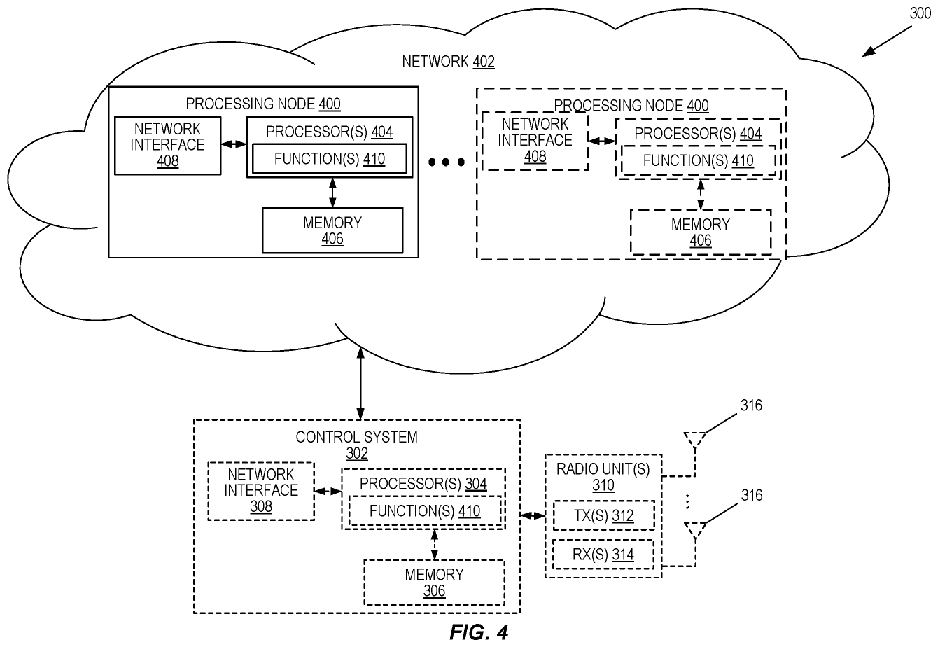

FIG. 4 is a schematic block diagram that illustrates a virtualized embodiment of the radio access node 300 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 300 in which at least a portion of the functionality of the radio access node 300 is implemented as a virtual component(s) (e.g., via a virtual machine(s) executing on a physical processing node(s) in a network(s)). As illustrated, in this example, the radio access node 300 may include the control system 302 and/or the one or more radio units 310, as described above. The control system 302 may be connected to the radio unit(s) 310 via, for example, an optical cable or the like. The radio access node 300 includes one or more processing nodes 400 coupled to or included as part of a network(s) 402. If present, the control system 302 or the radio unit(s) are connected to the processing node(s) 400 via the network 402. Each processing node 400 includes one or more processors 404 (e.g., CPUs, ASICs, FPGAs, and/or the like), memory 406, and a network interface 408.

In this example, functions 410 of the radio access node 300 described herein are implemented at the one or more processing nodes 400 or distributed across the one or more processing nodes 400 and the control system 302 and/or the radio unit(s) 310 in any desired manner. In some particular embodiments, some or all of the functions 410 of the radio access node 300 described herein are implemented as virtual components executed by one or more virtual machines implemented in a virtual environment(s) hosted by the processing node(s) 400. As will be appreciated by one of ordinary skill in the art, additional signaling or communication between the processing node(s) 400 and the control system 302 is used in order to carry out at least some of the desired functions 410. Notably, in some embodiments, the control system 302 may not be included, in which case the radio unit(s) 310 communicate directly with the processing node(s) 400 via an appropriate network interface(s).

In some embodiments, a computer program including instructions which, when executed by at least one processor, causes the at least one processor to carry out the functionality of radio access node 300 or a node (e.g., a processing node 400) implementing one or more of the functions 410 of the radio access node 300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 5 is a schematic block diagram of the radio access node 300 according to some other embodiments of the present disclosure. The radio access node 300 includes one or more modules 500, each of which is implemented in software. The module(s) 500 provide the functionality of the radio access node 300 described herein. This discussion is equally applicable to the processing node 400 of FIG. 4 where the modules 500 may be implemented at one of the processing nodes 400 or distributed across multiple processing nodes 400 and/or distributed across the processing node(s) 400 and the control system 302.

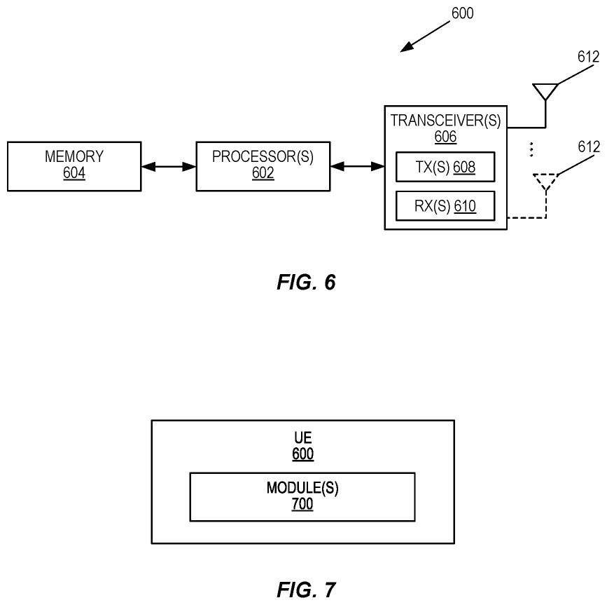

FIG. 6 is a schematic block diagram of a wireless communication device 600 according to some embodiments of the present disclosure. As illustrated, the wireless communication device 600 includes one or more processors 602 (e.g., CPUs, ASICs, FPGAs, and/or the like), memory 604, and one or more transceivers 606 each including one or more transmitters 608 and one or more receivers 610 coupled to one or more antennas 612. The transceiver(s) 606 includes radio-front end circuitry connected to the antenna(s) 612 that is configured to condition signals communicated between the antenna(s) 612 and the processor(s) 602, as will be appreciated by on of ordinary skill in the art. The processors 602 are also referred to herein as processing circuitry. The transceivers 606 are also referred to herein as radio circuitry. In some embodiments, the functionality of the wireless communication device 600 described above may be fully or partially implemented in software that is, e.g., stored in the memory 604 and executed by the processor(s) 602. Note that the wireless communication device 600 may include additional components not illustrated in FIG. 6 such as, e.g., one or more user interface components (e.g., an input/output interface including a display, buttons, a touch screen, a microphone, a speaker(s), and/or the like and/or any other components for allowing input of information into the wireless communication device 600 and/or allowing output of information from the wireless communication device 600), a power supply (e.g., a battery and associated power circuitry), etc.

In some embodiments, a computer program including instructions which, when executed by at least one processor, causes the at least one processor to carry out the functionality of the wireless communication device 600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the wireless communication device 600 according to some other embodiments of the present disclosure. The wireless communication device 600 includes one or more modules 700, each of which is implemented in software. The module(s) 700 provide the functionality of the wireless communication device 600 described herein.

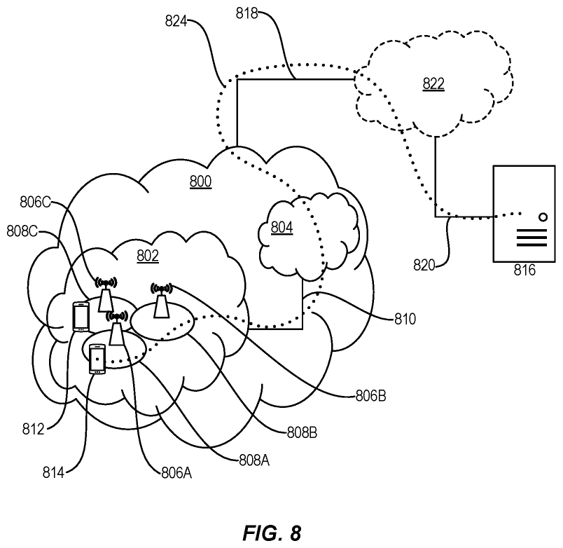

With reference to FIG. 8, in accordance with an embodiment, a communication system includes a telecommunication network 800, such as a 3GPP-type cellular network, which comprises an access network 802, such as a RAN, and a core network 804. The access network 802 comprises a plurality of base stations 806A, 806B, 806C, such as Node Bs, eNBs, gNBs, or other types of wireless Access Points (APs), each defining a corresponding coverage area 808A, 808B, 808C. Each base station 806A, 806B, 806C is connectable to the core network 804 over a wired or wireless connection 810. A first UE 812 located in coverage area 808C is configured to wirelessly connect to, or be paged by, the corresponding base station 806C. A second UE 814 in coverage area 808A is wirelessly connectable to the corresponding base station 806A. While a plurality of UEs 812, 814 are illustrated in this example, the disclosed embodiments are equally applicable to a situation where a sole UE is in the coverage area or where a sole UE is connecting to the corresponding base station 806.

The telecommunication network 800 is itself connected to a host computer 816, which may be embodied in the hardware and/or software of a standalone server, a cloud-implemented server, a distributed server, or as processing resources in a server farm. The host computer 816 may be under the ownership or control of a service provider, or may be operated by the service provider or on behalf of the service provider. Connections 818 and 820 between the telecommunication network 800 and the host computer 816 may extend directly from the core network 804 to the host computer 816 or may go via an optional intermediate network 822. The intermediate network 822 may be one of, or a combination of more than one of, a public, private, or hosted network; the intermediate network 822, if any, may be a backbone network or the Internet; in particular, the intermediate network 822 may comprise two or more sub-networks (not shown).

The communication system of FIG. 8 as a whole enables connectivity between the connected UEs 812, 814 and the host computer 816. The connectivity may be described as an Over-the-Top (OTT) connection 824. The host computer 816 and the connected UEs 812, 814 are configured to communicate data and/or signaling via the OTT connection 824, using the access network 802, the core network 804, any intermediate network 822, and possible further infrastructure (not shown) as intermediaries. The OTT connection 824 may be transparent in the sense that the participating communication devices through which the OTT connection 824 passes are unaware of routing of uplink and downlink communications. For example, the base station 806 may not or need not be informed about the past routing of an incoming downlink communication with data originating from the host computer 816 to be forwarded (e.g., handed over) to a connected UE 812. Similarly, the base station 806 need not be aware of the future routing of an outgoing uplink communication originating from the UE 812 towards the host computer 816.

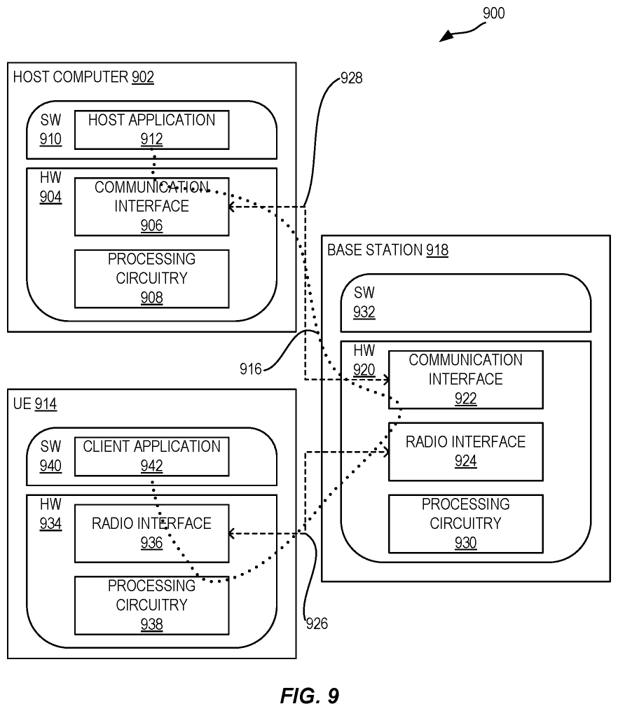

Example implementations, in accordance with an embodiment, of the UE, base station, and host computer discussed in the preceding paragraphs will now be described with reference to FIG. 9. In a communication system 900, a host computer 902 comprises hardware 904 including a communication interface 906 configured to set up and maintain a wired or wireless connection with an interface of a different communication device of the communication system 900. The host computer 902 further comprises processing circuitry 908, which may have storage and/or processing capabilities. In particular, the processing circuitry 908 may comprise one or more programmable processors, ASICs, FPGAs, or combinations of these (not shown) adapted to execute instructions. The host computer 902 further comprises software 910, which is stored in or accessible by the host computer 902 and executable by the processing circuitry 908. The software 910 includes a host application 912. The host application 912 may be operable to provide a service to a remote user, such as a UE 914 connecting via an OTT connection 916 terminating at the UE 914 and the host computer 902. In providing the service to the remote user, the host application 912 may provide user data which is transmitted using the OTT connection 916.

The communication system 900 further includes a base station 918 provided in a telecommunication system and comprising hardware 920 enabling it to communicate with the host computer 902 and with the UE 914. The hardware 920 may include a communication interface 922 for setting up and maintaining a wired or wireless connection with an interface of a different communication device of the communication system 900, as well as a radio interface 924 for setting up and maintaining at least a wireless connection 926 with the UE 914 located in a coverage area (not shown in FIG. 9) served by the base station 918. The communication interface 922 may be configured to facilitate a connection 928 to the host computer 902. The connection 928 may be direct or it may pass through a core network (not shown in FIG. 9) of the telecommunication system and/or through one or more intermediate networks outside the telecommunication system. In the embodiment shown, the hardware 920 of the base station 918 further includes processing circuitry 930, which may comprise one or more programmable processors, ASICs, FPGAs, or combinations of these (not shown) adapted to execute instructions. The base station 918 further has software 932 stored internally or accessible via an external connection.

The communication system 900 further includes the UE 914 already referred to. The UE's 914 hardware 934 may include a radio interface 936 configured to set up and maintain a wireless connection 926 with a base station serving a coverage area in which the UE 914 is currently located. The hardware 934 of the UE 914 further includes processing circuitry 938, which may comprise one or more programmable processors, ASICs, FPGAs, or combinations of these (not shown) adapted to execute instructions. The UE 914 further comprises software 940, which is stored in or accessible by the UE 914 and executable by the processing circuitry 938. The software 940 includes a client application 942. The client application 942 may be operable to provide a service to a human or non-human user via the UE 914, with the support of the host computer 902. In the host computer 902, the executing host application 912 may communicate with the executing client application 942 via the OTT connection 916 terminating at the UE 914 and the host computer 902. In providing the service to the user, the client application 942 may receive request data from the host application 912 and provide user data in response to the request data. The OTT connection 916 may transfer both the request data and the user data. The client application 942 may interact with the user to generate the user data that it provides.

It is noted that the host computer 902, the base station 918, and the UE 914 illustrated in FIG. 9 may be similar or identical to the host computer 816, one of the base stations 806A, 806B, 806C, and one of the UEs 812, 814 of FIG. 8, respectively. This is to say, the inner workings of these entities may be as shown in FIG. 9 and independently, the surrounding network topology may be that of FIG. 8.

In FIG. 9, the OTT connection 916 has been drawn abstractly to illustrate the communication between the host computer 902 and the UE 914 via the base station 918 without explicit reference to any intermediary devices and the precise routing of messages via these devices. The network infrastructure may determine the routing, which may be configured to hide from the UE 914 or from the service provider operating the host computer 902, or both. While the OTT connection 916 is active, the network infrastructure may further take decisions by which it dynamically changes the routing (e.g., on the basis of load balancing consideration or reconfiguration of the network).

The wireless connection 926 between the UE 914 and the base station 918 is in accordance with the teachings of the embodiments described throughout this disclosure. One or more of the various embodiments improve the performance of OTT services provided to the UE 914 using the OTT connection 916, in which the wireless connection 926 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime.

A measurement procedure may be provided for the purpose of monitoring data rate, latency, and other factors on which the one or more embodiments improve. There may further be an optional network functionality for reconfiguring the OTT connection 916 between the host computer 902 and the UE 914, in response to variations in the measurement results. The measurement procedure and/or the network functionality for reconfiguring the OTT connection 916 may be implemented in the software 910 and the hardware 904 of the host computer 902 or in the software 940 and the hardware 934 of the UE 914, or both. In some embodiments, sensors (not shown) may be deployed in or in association with communication devices through which the OTT connection 916 passes; the sensors may participate in the measurement procedure by supplying values of the monitored quantities exemplified above, or supplying values of other physical quantities from which the software 910, 940 may compute or estimate the monitored quantities. The reconfiguring of the OTT connection 916 may include message format, retransmission settings, preferred routing, etc.; the reconfiguring need not affect the base station 918, and it may be unknown or imperceptible to the base station 918. Such procedures and functionalities may be known and practiced in the art. In certain embodiments, measurements may involve proprietary UE signaling facilitating the host computer 902's measurements of throughput, propagation times, latency, and the like. The measurements may be implemented in that the software 910 and 940 causes messages to be transmitted, in particular empty or ‘dummy’ messages, using the OTT connection 916 while it monitors propagation times, errors, etc.

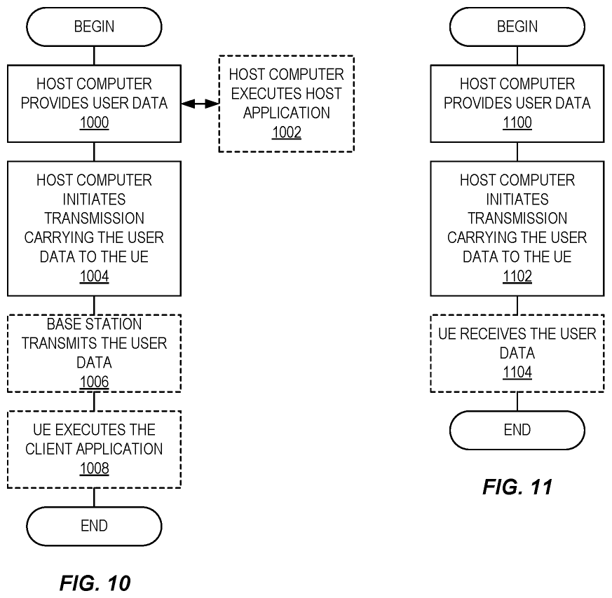

FIG. 10 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 10 will be included in this section. In step 1000, the host computer provides user data. In sub-step 1002 (which may be optional) of step 1000, the host computer provides the user data by executing a host application. In step 1004, the host computer initiates a transmission carrying the user data to the UE. In step 1006 (which may be optional), the base station transmits to the UE the user data which was carried in the transmission that the host computer initiated, in accordance with the teachings of the embodiments described throughout this disclosure. In step 1008 (which may also be optional), the UE executes a client application associated with the host application executed by the host computer.

FIG. 11 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 1 will be included in this section. In step 1100 of the method, the host computer provides user data. In an optional sub-step (not shown) the host computer provides the user data by executing a host application. In step 1102, the host computer initiates a transmission carrying the user data to the UE. The transmission may pass via the base station, in accordance with the teachings of the embodiments described throughout this disclosure. In step 1104 (which may be optional), the UE receives the user data carried in the transmission.

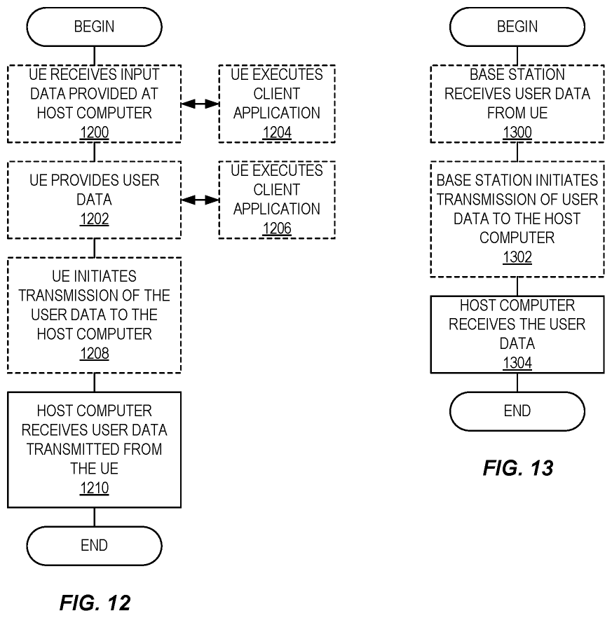

FIG. 12 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 2 will be included in this section. In step 1200 (which may be optional), the UE receives input data provided by the host computer. Additionally or alternatively, in step 1202, the UE provides user data. In sub-step 1204 (which may be optional) of step 1200, the UE provides the user data by executing a client application. In sub-step 1206 (which may be optional) of step 1202, the UE executes a client application which provides the user data in reaction to the received input data provided by the host computer. In providing the user data, the executed client application may further consider user input received from the user. Regardless of the specific manner in which the user data was provided, the UE initiates, in sub-step 1208 (which may be optional), transmission of the user data to the host computer. In step 1210 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station, and a UE which may be those described with reference to FIGS. 8 and 9. For simplicity of the present disclosure, only drawing references to FIG. 13 will be included in this section. In step 1300 (which may be optional), in accordance with the teachings of the embodiments described throughout this disclosure, the base station receives user data from the UE. In step 1302 (which may be optional), the base station initiates transmission of the received user data to the host computer. In step 1304 (which may be optional), the host computer receives the user data carried in the transmission initiated by the base station.

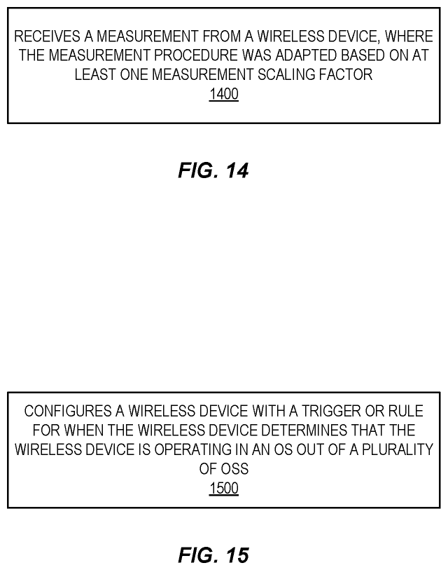

FIG. 14 is a flow chart that illustrates the operation of network node (e.g., base station 102) for enabling adaptation of a measurement procedure at a wireless device (e.g., wireless device 112) in accordance with an embodiment of the present disclosure. As illustrated, the network node receives a measurement from a wireless device, where the measurement procedure was adapted based on at least one measurement scaling factor (step 1400). The measurement procedure may be adapted at the wireless device based on any of the wireless device related embodiments described herein.

FIG. 15 is a flow chart that illustrates the operation of network node (e.g., base station 102) for triggering adaptation of a measurement procedure at a wireless device (e.g., wireless device 112) in accordance with an embodiment of the present disclosure. As illustrated, the network node configures a wireless device with a trigger or rule for when the wireless device determines that the wireless device is operating in an OS out of a plurality of OSs (step 1500). This configuration may include any of the configuration information sent from the network or network node to the wireless device or UE in any of the UE related embodiments described above. In one embodiment, the trigger or rule comprises the wireless device evaluating the status of its OS when operating in any low RRC activity state e.g., in idle state, in inactive state, etc. (i.e., a trigger or rule that the wireless device is to determine its OS when operating in any low RRC activity state). In another embodiment, the trigger or rule comprises the wireless device evaluating the status of its OS when operating in a particular type of low RRC activity state e.g., only in idle state or only in inactive state, etc. (i.e., a trigger or rule that the wireless device is to determine its OS when operating in a certain low RRC activity state). In another embodiment, the trigger or rule comprises the wireless device evaluating the status of its OS when it is explicitly configured by the base station to perform the evaluation (i.e., a trigger or rule that the wireless device is to determine its OS when the wireless device is explicitly configured to do so by the network node). In one embodiment, the trigger or rule comprises the wireless device evaluating the status of its OS if the wireless device battery power falls below certain threshold (e.g., below 25% of the maximum battery power) (i.e., a trigger or rule that the wireless device is to determine its OS if, or responsive to, the wireless device battery power falls below a certain threshold). Note that the trigger or rule may also be said to be a trigger or rule for triggering adaptation of a measurement procedure(s) at the wireless device based on a determined operational state of the wireless device.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless device for adapting a measurement procedure, the method comprising: determining (200) that the wireless device is operating in an Operational Scenario, OS, out of a plurality of OSs; determining (202) at least one measurement scaling factor based on the determined OS; and adapting (204) at least one measurement procedure based on the at least one measurement scaling factor.

Embodiment 2: The method of embodiment 1 wherein one of the plurality of OSs is related to the wireless device being stationary or moving with a speed below certain threshold.

Embodiment 3: The method of any of embodiments 1 to 2 wherein one of the plurality of OSs is related to the wireless device being at least not physically located at a cell edge and/or the wireless device is operating in the center of the cell or close to the serving base station.

Embodiment 4: The method of any of embodiments 1 to 3 wherein each of the plurality of OSs is associated with its respective one or more criteria or conditions.

Embodiment 5: The method of embodiment 4 wherein determining that the wireless device is operating in the determined OS comprises determining the respective one or more criteria or conditions of the determined OS are met.

Embodiment 6: The method of any of embodiments 1 to 5 wherein each of the plurality of OSs is associated with at least one measurement scaling factor.

Embodiment 7: The method of any of embodiments 1 to 6 wherein determining the at least one measurement scaling factor further comprises determining the at least one measurement scaling factor based on the determined OS and a priority level of a carrier configured for measurements.

Embodiment 8: The method of embodiment 7 wherein the priority level of the carrier is one of: a low priority level, an equal priority level, and a higher priority level.

Embodiment 9: The method of any of embodiments 1 to 8 wherein each of the plurality of OSs is associated with a plurality of measurement scaling factors.

Embodiment 10: The method of embodiment 9 wherein each of the plurality of measurement scaling factors is of the same type for deriving the same type of measurement requirement.

Embodiment 11: The method of embodiment 10 wherein determining the at least one measurement scaling factor comprises determining the at least one measurement scaling factor based on a rule and the plurality of measurement scaling factors of the determined OS.

Embodiment 12: The method of embodiment 11 wherein the rule is based on a number of carriers configured for the measurements.

Embodiment 13: The method of embodiment 11 wherein the rule is based on is based on the type of Radio Access Technologies, RATs, of the carriers configured for the measurements.

Embodiment 14: The method of any of embodiments 9 to 13 wherein the plurality of measurement scaling factors comprise different types of measurement scaling factors for deriving different types of measurement requirements.

Embodiment 15: The method of embodiment 14 wherein the different types of measurement requirements comprise measurement delay requirements.

Embodiment 16: The method of any of embodiments 14 to 15 wherein the different types of measurement requirements comprise requirements related to measurement accuracy levels.

Embodiment 17: The method of any of embodiments 1 to 16 wherein determining that the wireless device is operating in an OS is a result of a trigger or rule, which can be pre-defined or configured by the network node.

Embodiment 18: The method of embodiment 17 wherein the rule comprises the wireless device evaluating the status of its OS when operating in any low Radio Resource Control, RRC, activity state e.g., in idle state, in inactive state, etc.

Embodiment 19: The method of embodiment 17 wherein the rule comprises the wireless device evaluating the status of its OS when operating in a particular type of low RRC activity state e.g., only in idle state or only in inactive state, etc.

Embodiment 20: The method of embodiment 17 wherein the rule comprises the wireless device evaluating the status of its OS when it is explicitly configured by the network node to perform the evaluation.

Embodiment 21: The method of embodiment 17 wherein the rule comprises the wireless device evaluating the status of its OS if the wireless device battery power falls below certain threshold (e.g., below 25% of the maximum battery power).

Embodiment 22: The method of any of the previous embodiments, further comprising: providing user data; and forwarding the user data to a host computer via the transmission to the base station.

### Group B Embodiments

Embodiment 23: A method performed by a base station for adapting a measurement procedure, the method comprising: receiving a measurement from a wireless device where the measurement procedure was adapted based on at least one measurement scaling factor.

Embodiment 24: The method of embodiment 23 wherein the measurement procedure was adapted based on any of the Group A embodiments.

Embodiment 25: A method performed by a base station for adapting a measurement procedure, the method comprising: configuring a wireless device with a trigger or rule for when the wireless device determines that the wireless device is operating in an Operational Scenario, OS, out of a plurality of OSs.

Embodiment 26: The method of embodiment 25 wherein the rule comprises the wireless device evaluating the status of its OS when operating in any low RRC activity state e.g., in idle state, in inactive state, etc.

Embodiment 27: The method of embodiment 25 wherein the rule comprises the wireless device evaluating the status of its OS when operating in a particular type of low RRC activity state e.g., only in idle state or only in inactive state, etc.

Embodiment 28: The method of embodiment 25 wherein the rule comprises the wireless device evaluating the status of its OS when it is explicitly configured by the base station to perform the evaluation.

Embodiment 29: The method of embodiment 25 wherein the rule comprises the wireless device evaluating the status of its OS if the wireless device battery power falls below certain threshold (e.g., below 25% of the maximum battery power).

Embodiment 30: The method of any of the previous embodiments, further comprising: obtaining user data; and forwarding the user data to a host computer or a wireless device.

### Group C Embodiments

Embodiment 31: A wireless device for adapting a measurement procedure, the wireless device comprising: processing circuitry configured to perform any of the steps of any of the Group A embodiments; and power supply circuitry configured to supply power to the wireless device.

Embodiment 32: A base station for adapting a measurement procedure, the base station comprising: processing circuitry configured to perform any of the steps of any of the Group B embodiments; and power supply circuitry configured to supply power to the base station.

Embodiment 33: A User Equipment, UE, for adapting a measurement procedure, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 34: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 35: The communication system of the previous embodiment further including the base station.

Embodiment 36: The communication system of the previous 2 embodiments, further including the UE, wherein the UE is configured to communicate with the base station.

Embodiment 37: The communication system of the previous 3 embodiments, wherein: the processing circuitry of the host computer is configured to execute a host application, thereby providing the user data; and the UE comprises processing circuitry configured to execute a client application associated with the host application.

Embodiment 38: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 39: The method of the previous embodiment, further comprising, at the base station, transmitting the user data.

Embodiment 40: The method of the previous 2 embodiments, wherein the user data is provided at the host computer by executing a host application, the method further comprising, at the UE, executing a client application associated with the host application.

Embodiment 41: A User Equipment, UE, configured to communicate with a base station, the UE comprising a radio interface and processing circuitry configured to perform the method of the previous 3 embodiments.

Embodiment 42: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 43: The communication system of the previous embodiment, wherein the cellular network further includes a base station configured to communicate with the UE.

Embodiment 44: The communication system of the previous 2 embodiments, wherein: the processing circuitry of the host computer is configured to execute a host application, thereby providing the user data; and the UE's processing circuitry is configured to execute a client application associated with the host application.

Embodiment 45: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 46: The method of the previous embodiment, further comprising at the UE, receiving the user data from the base station.

Embodiment 47: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 48: The communication system of the previous embodiment, further including the UE.

Embodiment 49: The communication system of the previous 2 embodiments, further including the base station, wherein the base station comprises a radio interface configured to communicate with the UE and a communication interface configured to forward to the host computer the user data carried by a transmission from the UE to the base station.

Embodiment 50: The communication system of the previous 3 embodiments, wherein: the processing circuitry of the host computer is configured to execute a host application; and the UE's processing circuitry is configured to execute a client application associated with the host application, thereby providing the user data.

Embodiment 51: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 52: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 53: The method of the previous embodiment, further comprising, at the UE, providing the user data to the base station.

Embodiment 54: The method of the previous 2 embodiments, further comprising: at the UE, executing a client application, thereby providing the user data to be transmitted; and at the host computer, executing a host application associated with the client application.

Embodiment 55: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 56: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 57: The communication system of the previous embodiment further including the base station.

Embodiment 58: The communication system of the previous 2 embodiments, further including the UE, wherein the UE is configured to communicate with the base station.

Embodiment 59: The communication system of the previous 3 embodiments, wherein: the processing circuitry of the host computer is configured to execute a host application; and the UE is configured to execute a client application associated with the host application, thereby providing the user data to be received by the host computer.

Embodiment 60: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 61: The method of the previous embodiment, further comprising at the base station, receiving the user data from the UE.

Embodiment 62: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a wireless device for adapting a measurement procedure, the method comprising:
determining that the wireless device is operating in an Operational Scenario, OS, out of a plurality of OSs, wherein one of the plurality of OSs is related to the wireless device being at least not physically located at a cell edge of a serving cell of the wireless device;
determining at least one measurement scaling factor based on the determined OS; and
adapting at least one measurement procedure based on the at least one measurement scaling factor.

2. The method of claim 1 wherein one of the plurality of OSs is related to the wireless device operating in low mobility.

3. The method of claim 1 wherein one of the plurality of OSs is related to the wireless device being stationary or moving with a speed below certain threshold.

4. The method of claim 1 wherein one of the plurality of OSs is related to the wireless device operating in a center of the serving cell or close to a serving base station that provides the serving cell.

5. The method of claim 1 wherein each of the plurality of OSs is associated with a respective one or more criteria or conditions.

6. The method of claim 5 wherein determining that the wireless device is operating in the determined OS comprises determining that the respective one or more criteria or conditions of the determined OS are met.

7. The method of claim 1 wherein each of the plurality of OSs is associated with at least one measurement scaling factor.

8. The method of claim 1 wherein determining the at least one measurement scaling factor further comprises determining the at least one measurement scaling factor based on the determined OS and a priority level of a carrier configured for measurements.

9. The method of claim 8 wherein the priority level of the carrier is relative to a priority of a carrier of a serving cell of the wireless device.

10. The method of claim 1 wherein each of the plurality of OSs is associated with a plurality of measurement scaling factors.

11. The method of claim 10 wherein each of the plurality of measurement scaling factors is of the same type for deriving the same type of measurement requirement.

12. The method of claim 11 wherein determining the at least one measurement scaling factor comprises determining the at least one measurement scaling factor based on a rule and the plurality of measurement scaling factors of the determined OS.

13. The method of claim 12 wherein the rule is based on a number of carriers configured for the measurements.

14. The method of claim 12 wherein the rule is based on is based on the type of Radio Access Technologies, RATs, of the carriers configured for the measurements.

15. The method of claim 10 wherein the plurality of measurement scaling factors comprise different types of measurement scaling factors for deriving different types of measurement requirements.

16. The method of claim 15 wherein the different types of measurement requirements comprise measurement delay requirements.

17. The method of claim 15 wherein the different types of measurement requirements comprise requirements related to measurement accuracy levels.

18. The method of claim 1 wherein determining that the wireless device is operating in an OS comprises determining that the wireless device is operating in an OS as a result of a trigger or rule, wherein the trigger or rule is either pre-defined or configured by a network node.

19. The method of claim 18 wherein the trigger or rule comprises a trigger or rule that the wireless device is to determine its OS when operating in any low Radio Resource Control, RRC, activity state.

20. The method of claim 18 wherein the trigger or rule comprises a trigger or rule that the wireless device is to determine its OS when operating in a particular type of low Radio Resource Control, RRC, activity state.

21. The method of claim 18 wherein the trigger or rule comprises a trigger or rule that the wireless device is to determine its OS when the wireless device is explicitly configured by a network node to determine its OS.

22. The method of claim 18 wherein the trigger or rule comprises a trigger or rule that the wireless device is to determine its OS if the wireless device battery power falls below certain threshold.

23. The method of claim 1 wherein adapting the at least one measurement procedure based on the at least one measurement scaling factor comprises applying the at least one measurement scaling factor to one or more reference requirements for the at least one measurement procedure.

24. A wireless device for adapting a measurement procedure, the wireless device configured to:
determine that the wireless device is operating in an Operational Scenario, OS, out of a plurality of OSs, wherein one of the plurality of OSs is related to the wireless device being at least not physically located at a cell edge of a serving cell of the wireless device;
determine at least one measurement scaling factor based on the determined OS; and
adapt at least one measurement procedure based on the at least one measurement scaling factor.

25. (canceled)

26. A wireless device for adapting a measurement procedure, the wireless device comprising:
one or more transmitters;
one or more receivers; and
processing circuitry associated with the one or more transmitters and the one or more receivers, the processing circuitry configured to cause the wireless device to:
determine that the wireless device is operating in an Operational Scenario, OS, out of a plurality of OSs, wherein one of the plurality of OSs is related to the wireless device being at least not physically located at a cell edge of a serving cell of the wireless device;
determine at least one measurement scaling factor based on the determined OS; and
adapt at least one measurement procedure based on the at least one measurement scaling factor.

27. (canceled)
